(19) United States
(12) Patent Application Publication
(10) Pub. No.: US 2018/0184818 A1
(43) Pub. Date: Jul. 5, 2018

(54) Transparent Display Frame

(71) Applicant: Vicki Jordan Gaar, Winnfield, LA (US)

(72) Inventor: Vicki Jordan Gaar, Winnfield, LA (US)

(21) Appl. No.: 15/858,631

(22) Filed: Dec. 29, 2017

Related U.S. Application Data
(60) Provisional application No. 62/441,622, filed on Jan. 3, 2017.

(51) Int. Cl. A47G 1/06; G09F 11/20; G09F 1/12; A47F 3/00; G09F 7/10

(52) U.S. Cl. CPC A47G 1/06; G09F 11/20; B42D 1/08; A47F 3/005; G09F 7/10; G09F 1/12

(57) ABSTRACT

A transparent display frame includes a front plate having a planar configuration and a back plate having a planar configuration opposite the front plate, the front and back plates being parallel to and displaced from one another so as to define an interior area therebetween for receiving the media item. The display frame includes a pair of side walls and a bottom wall that are closed and defines an open top side for allowing access into or out of the interior area and through which the collectible media item is selectively inserted into the interior area. The display frame may be constructed of transparent material. A dust cover is coupled to one of the back plate or said front plate, the dust cover being movable between a covered configuration not allowing access to the interior area and an uncovered configuration allowing access to the interior area.

### REFERENCE TO RELATED APPLICATIONS

This application claims the benefit of provisional patent application U.S. Ser. No. 62/441,622 filed Jan. 3, 2017 titled Acrylic Display Frame for Collectible Media which is incorporated herein by reference.

### BACKGROUND OF THE INVENTION

The present invention relates generally to display frames and, more particularly, to a transparent acrylic frame for displaying collectible media while providing protection from dust, dirt, wear and u/v rays and giving easy access to the collectible media. For the purpose of this invention, collectible media may include but is not limited to: LP (33⅓ rpm), 45 rpm, and 78 rpm records and record albums, comic books, magazines, compact discs and posters.

Traditional display frames include a border made of wood, metal, or plastic that surrounds the display item, e.g. a photograph or painting, and may include bulky mounting hardware or require some assembly. In addition, once the display item is inserted into the frame and its receiving area, the display item is no longer easily accessible or removable—at least not without removing the frame from a wall mount and opening or removing structures to gain access to the display item.

Although presumably suitable for their intended purposes, the existing display frames do not allow 1) easy insertion for display purposes, 2) easy removal so that the display item can also be used or viewed away from the frame, or 3) display on a wall without any border frame members being visible. There is a need and desire to display collectible media items such as record albums and their sleeves, comic book covers, compact discs and their sleeves, articles, newspapers, and the like. Displaying such collectible items is desirable in a manner other than in traditional photograph frames and in a manner that protects the displayed item from dust, debris, UV rays, and the like while still providing easy access to the item for use away from the display frame.

Therefore, it would be desirable to have a transparent display frame that overcomes the limitations and disadvantages of traditional display frames so that collectible display items may be displayed and protected more effectively.

### SUMMARY OF THE INVENTION

A transparent display frame according to a preferred embodiment of the present invention includes a front plate having a planar configuration and a back plate having a planar configuration opposite the front plate, the front and back plates being parallel to and displaced from one another so as to define an interior area therebetween for receiving the media item. The display frame includes a pair of side walls and a bottom wall that are closed and defines an open top side for allowing access into or out of the interior area and through which the collectible media item is selectively inserted into the interior area. The display frame may be constructed of transparent material. A dust cover is coupled to one of the back plate or said front plate, the dust cover being movable between a covered configuration not allowing access to the interior area and an uncovered configuration allowing access to the interior area.

Therefore, a general object of this invention is to provide a transparent display frame having a single open side for receiving a media piece therein as a wall hanging display.

Another object of this invention is to provide a transparent display frame, as aforesaid, for protecting a media item such as a record album and/or its sleeve from dust and damage yet making it easily accessible.

Still another object of this invention is to provide a transparent display frame, as aforesaid, that is transparent such that the media item is visible even when mounted to a wall.

Yet another object of this invention is to provide a transparent display frame, as aforesaid, that is transparent such that the frames may be mounted to a wall in a mysterious manner as no frame or hardware is visible.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a front perspective view of a transparent display frame according to a preferred embodiment of the present invention;

FIG. 2 is a rear perspective view of the transparent display frame as in FIG. 1;

FIG. 3a to 3e are types of dust cover capable of use in closing an open top side of the display frame shown in FIG. 1;

FIG. 4 is a perspective view of the transparent display frame as in FIG. 1, illustrated with a collectible media item partially inserted therein;

FIG. 5 is a perspective of the display frame as in FIG. 1 in use with a pivotal dust cover in a closed configuration;

FIG. 6 is a perspective of the display frame as in FIG. 1 in use with a pivotal dust cover in an open configuration;

FIG. 7 is a perspective of the display frame as in FIG. 1 in use with a plug dust cover in a closed configuration;

FIG. 8 is a perspective of the display frame as in FIG. 1 in use with a plug dust cover in an open configuration;

FIG. 9 is a perspective of the display frame as in FIG. 1 in use with a pivotal end dust cover in a closed configuration;

FIG. 10 is a perspective of the display frame as in FIG. 1 in use with a pivotal end dust cover in an open configuration;

FIG. 11 is a perspective of the display frame as in FIG. 1 in use with a sliding dust cover in a closed configuration; and

FIG. 12 is a perspective of the display frame as in FIG. 1 in use with a sliding dust cover in an open configuration;

### DESCRIPTION OF THE PREFERRED EMBODIMENT

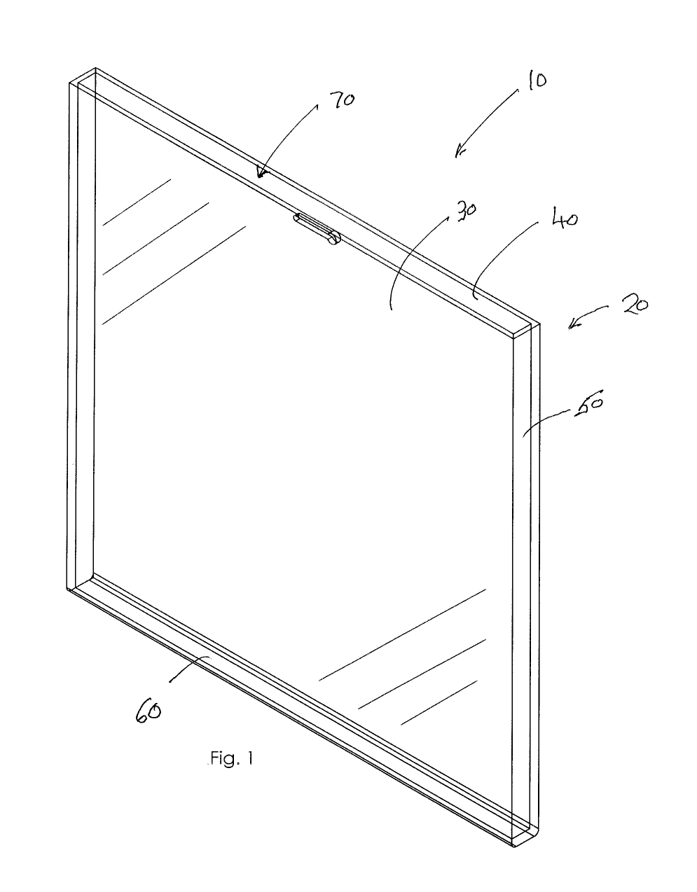

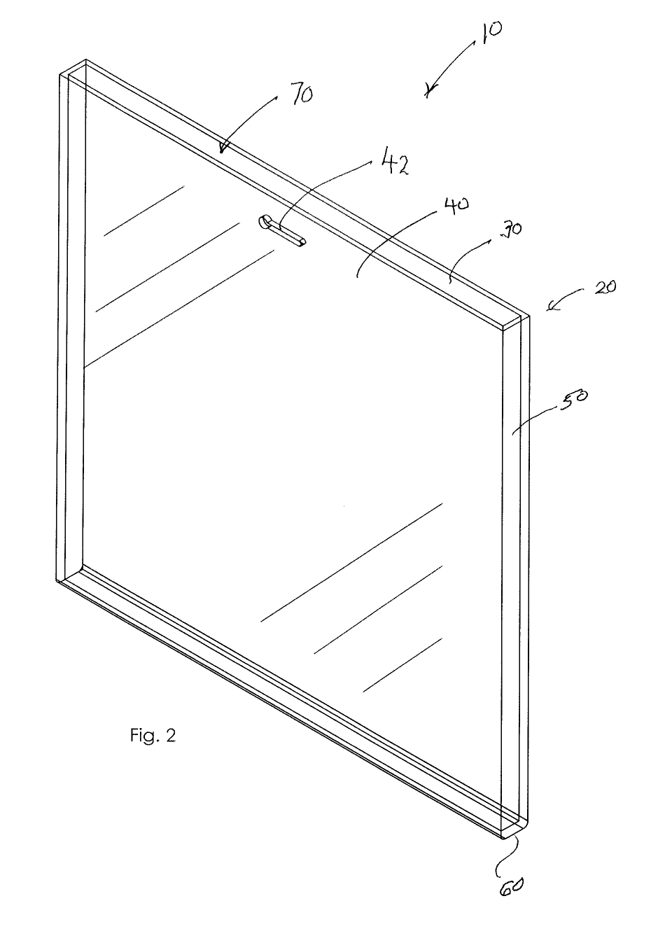

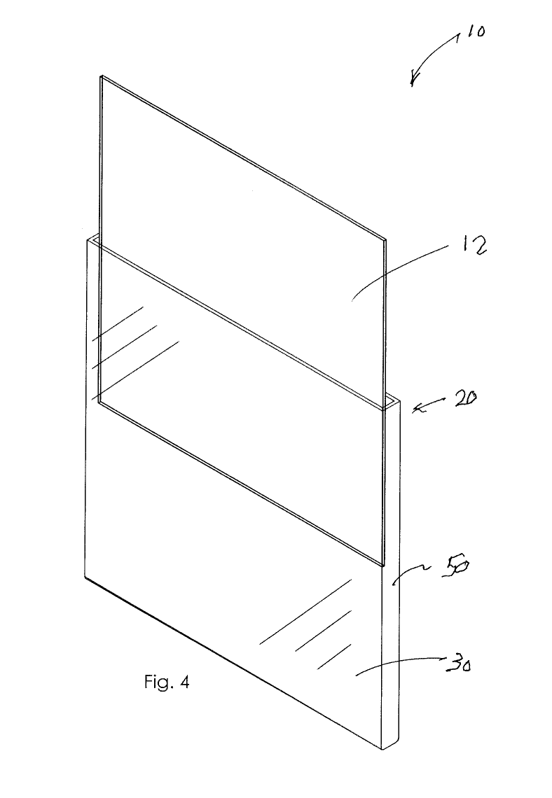

A display frame according to a preferred embodiment of the present invention will now be described with reference to FIGS. 1 to 12 of the accompanying drawings. The display frame 10 may be constructed of a transparent material and be configured to display a collectible media item 12, such as a record album, a comic book, a magazine cover, a compact disc case, a poster, or the like.

The display frame 10 may include a housing 20 having spaced apart front and back plates and connecting side walls and a bottom wall configured to enclose three adjacent sides of the housing while leaving a top side open allowing access into an interior area defined by respective plates and side walls. Preferably, the interior area has a geometric area (length and width) slightly larger than a geometric area of the collectible media item 12 to be received therein. For instance, the interior area is larger than a record album or cover that may be inserted therein.

More particularly, the housing 20 may include a front plate 30 having a flat or planar configuration. Preferably, the front plate 30 has a square shape configuration. Similarly, the housing 20 may include a back plate 40 having a flat or planar configuration. The back plate 40 may also have a square shape configuration. The front and back plates may be oriented parallel to one another, i.e. have parallel planes and be displaced so as to define an interior area therebetween for receiving a collectible media item 12 as will be described later. The front and black plates may be aligned such that associated peripheral edges of each plate are adjacent to one another. The front plate 30, back plate 40, and interior area therebetween may have a combined thickness of about 2 mm to 5 mm. In a more robust embodiment, each plate may singly include a thickness of about 2 mm to 5 mm.

The housing 20 may include a pair of side walls 50 opposed and parallel to one another, each side wall 50 connecting associated side peripheral edges of the front and back plates 30, 40, respectively. In other words, the side walls 50 are perpendicular to the front and back plates 30, 40 and cause the sides of the housing 20 to be closed and not allow access into or out of the interior area. Similarly, the housing 20 includes a bottom wall 60 coupled to associated bottom peripheral edges of the front plate 30 and back plate 40, respectively. The bottom wall 60 causes the bottom of the housing 20 to be closed and to not allow access into or out of the interior area via the bottom. It is understood that the entire housing may have a unitary molded construction and that references to side and bottom peripheral edges is merely for the sake of clarifying the location and extent of the side and bottom walls, respectively.

Conversely, top peripheral edges of the front 30 and back 40 plates, respectively, may define an open top side 70 that allow access into or out of the interior area between the plates. It is intended that the open side is the top side so that the collectible media item received into the interior area is not susceptible to falling out inadvertently such as by means of gravity, during mounting to a wall, or even by vibrations caused by an earthquake.

Preferably, the front plate 30, back plate, side walls 50, and bottom wall 60 of the housing 20 of the display frame 10 are constructed of a transparent material so that there is no evidence that the collectible article being displayed is being held by a traditional frame. In fact, the product described herein may be marketed as “Phantom Frames™” that give the appearance that the collectible item is suspended in the air or on a wall without the assistance of a traditional wooden frame or hardware. Preferably, the housing 20 is constructed of acrylic, which may be obtained as an acrylic sheet and molded into the shape and configuration described above. Of course, other materials having transparent characteristics may also be utilized, such as glass, Plexiglas®, plastic, and polycarbonate.

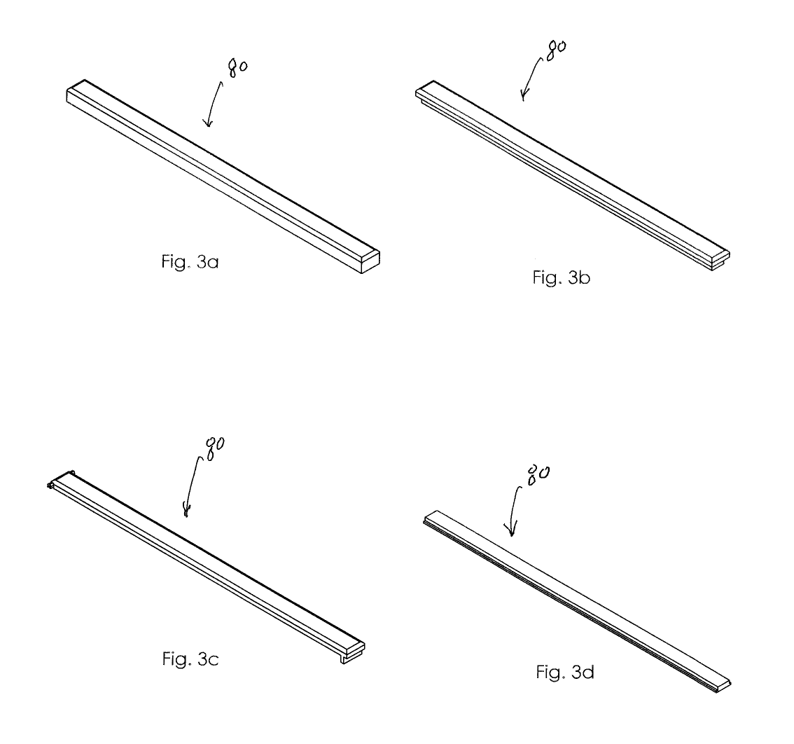

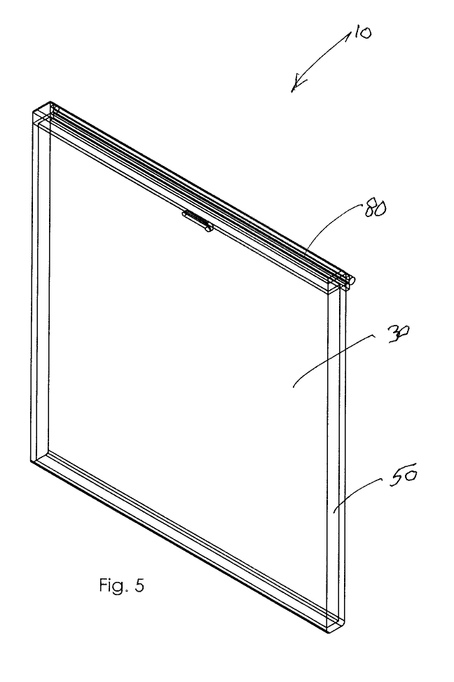

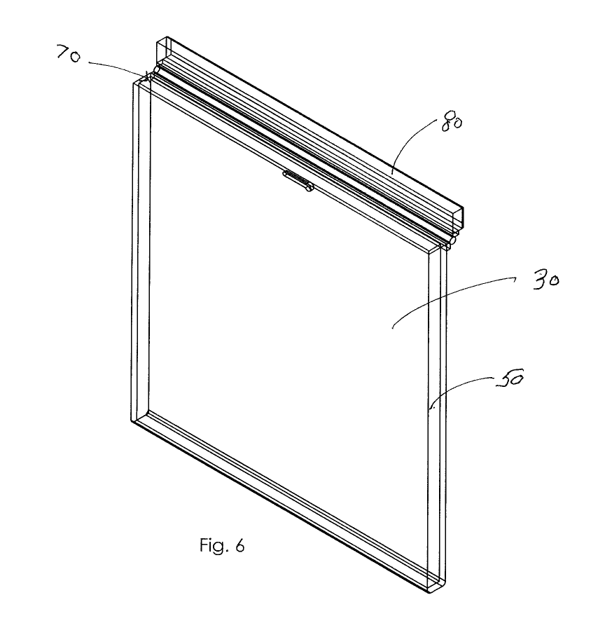

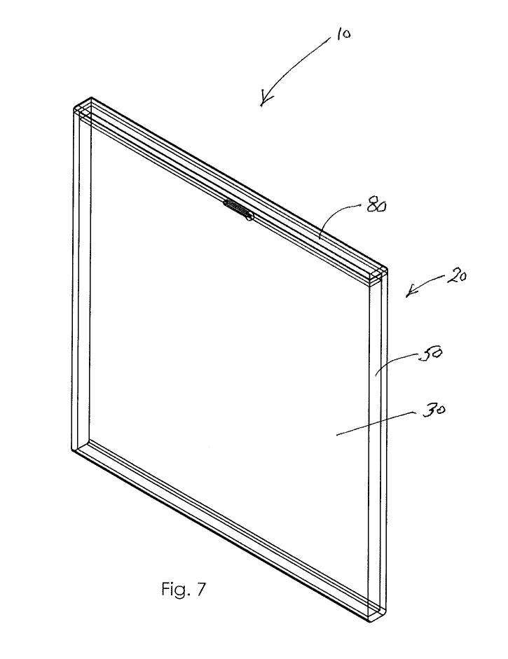

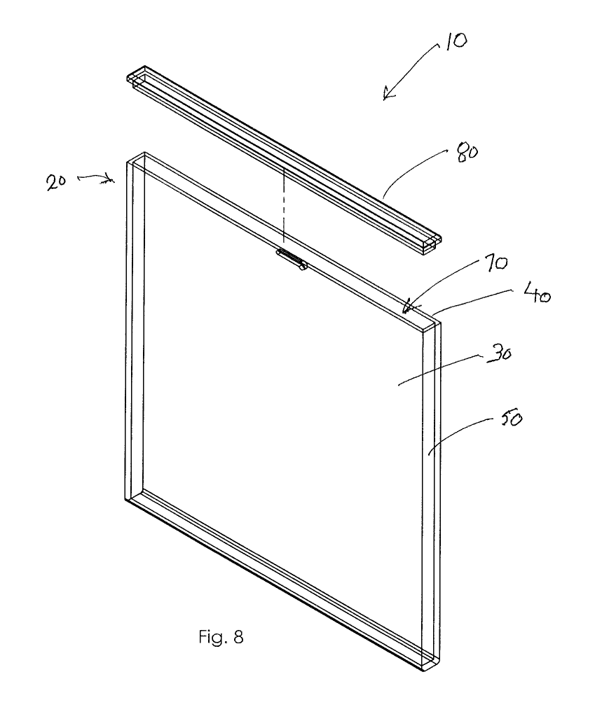

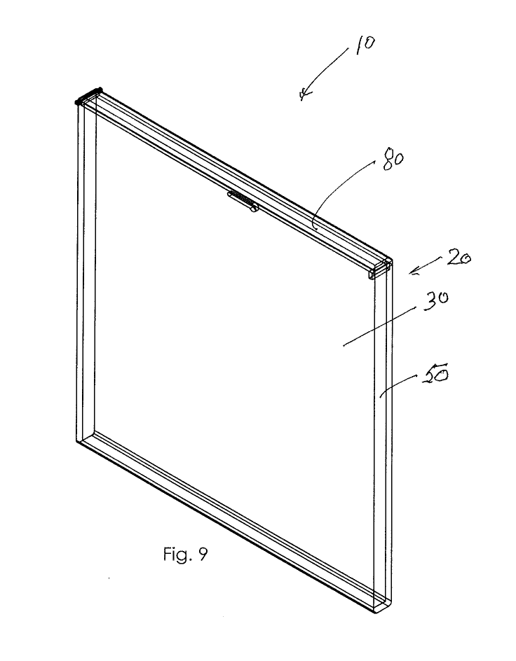

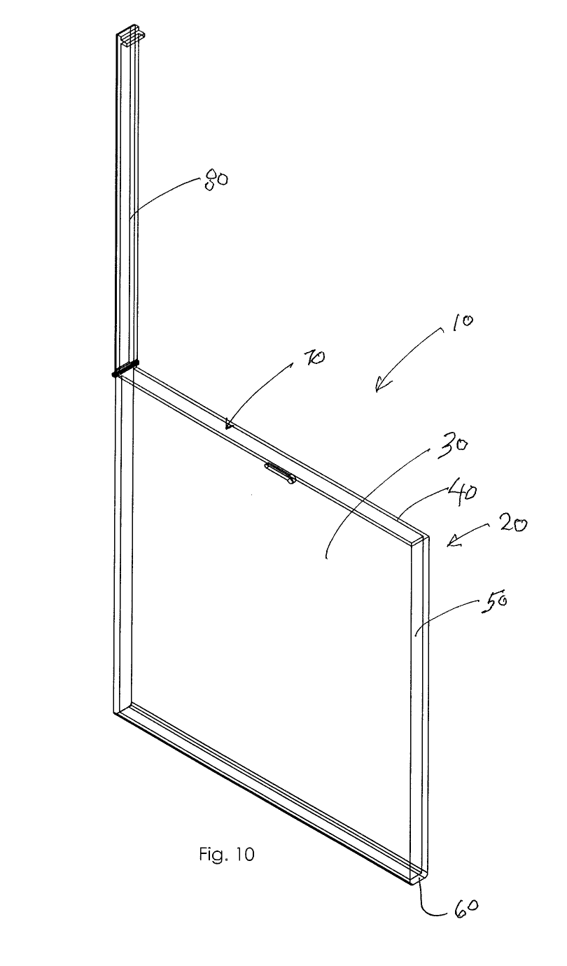

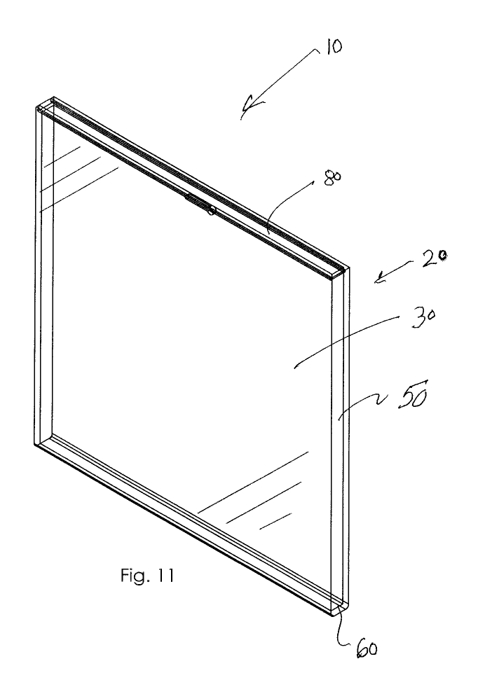

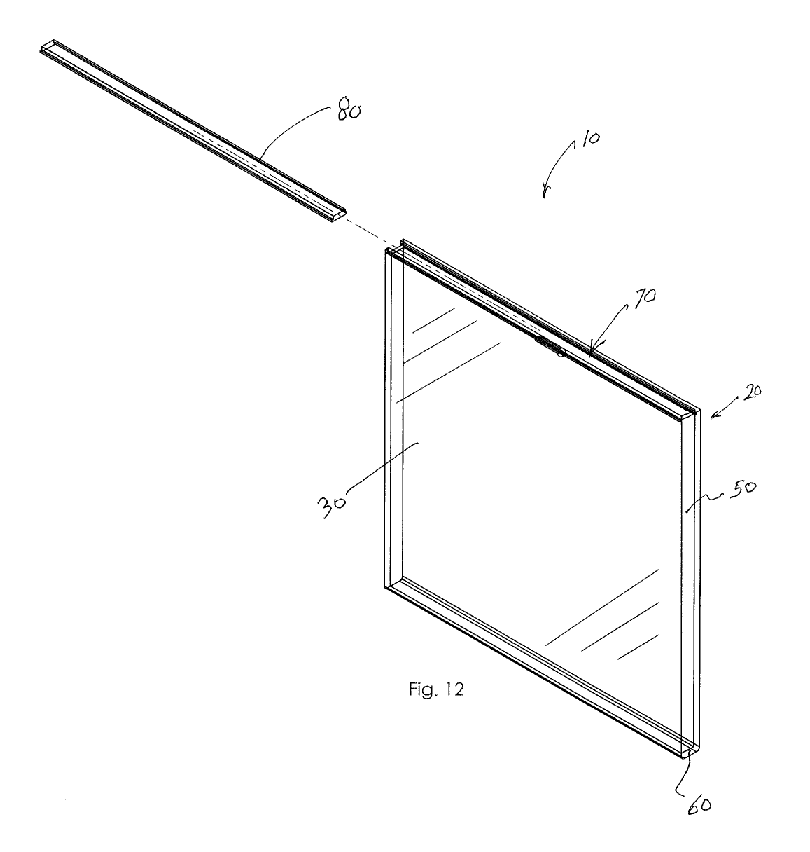

In another aspect, the display frame 10 according to the present invention may include a dust cover 80 selectively positioned to expose or cover the open top side 70. Variations in how the dust cover 80 may be attached to the display frame 10 are shown in FIGS. 3a to 3e and then in operation in FIGS. 5 to 12. It is understood that the display frame 10 is the same (same embodiment) regardless which dust cover is used. Reference numeral 80 is intentionally used in each drawing in which a dust cover is depicted. The dust cover 80 is intended to prevent dust and debris from entering into the open area which may cause damage to the collectible media item. The dust cover 80 may be coupled to the back plate 40, such as with a hinge, and be movable between a closed configuration covering the open top side 70 so as to not allow access to the interior area (FIG. 5) and an open configuration displaced from the open top side 70 so as to allow access to the interior area (FIG. 6). In a variation, the dust cover 80 may be pivotally coupled to either the back plate 40 or the front plate 30 and pivotally movable by a user between open or closed configurations. In another variation, the dust cover 80 may be constructed in the form of an elongate plug and deployed to close the open top side 70 (FIG. 7) or removed to allow access therethrough (FIG. 8). In another variation, the dust cover 80 may be coupled to a side wall 50 and be pivoted between a closed configuration covering the open top side 70 (FIG. 9) and an open configuration allowing access to the open top side 70 (FIG. 10). Still further, the dust cover 80 may be slidably coupled to the front and rear plate edges and be movable slidably between closed (FIG. 11) and open configurations (FIG. 12).

In another aspect, mounting hardware (not shown) may be attached to an exterior surface of the back plate 40 that is configured for mounting the display frame 10 to a wall. In an embodiment, the back plate 40 may define a keyhole 42 or other aperture so that the display frame 10 may be hung on a simple wall fastener such as a nail.

In use, the display frame 10 or a plurality of display frames may be mounted to a wall. The, a collectible media item, such as a record album or its holder or other collectible items described previously may be inserted into the interior area via the open top side 70 for display therein. The dust cover 80, when implemented, may then be moved to the closed configuration so as to prevent access therein, such as by dust or inadvertent removal of the collectible item.

It is understood that while certain forms of this invention have been illustrated and described, it is not limited thereto except insofar as such limitations are included in the following claims and allowable functional equivalents thereof.

1. A display frame for displaying a collectible media item, comprising:
a housing having a front plate having a planar configuration and a back plate having a planar configuration opposite said front plate, said front and back plates being parallel to and displaced from one another so as to define an interior area therebetween for receiving the media item;
wherein said housing includes a pair of side walls opposed to one another and coupled to associated side peripheral edges of said front plate and said back plate, respectively, said pair of side walls extending along said associated side peripheral edges so as to prevent access to said interior area;
wherein said housing includes a bottom wall coupled to associated bottom peripheral edges of said front plate and said back plate, respectively, said bottom wall extending along said associated bottom peripheral edges so as to prevent access to said interior area;
wherein said housing defines an open top side extending along associated top peripheral edges of said front plate and said back plate, respectively, that allows access into said interior area;
wherein said first plate, said back plate, said pair of side walls, and said bottom wall are constructed of a transparent material.

2. The display frame as in claim 1, wherein said housing has a unitary molded construction.

3. The display frame as in claim 2, wherein said housing is constructed of an acrylic sheet.

4. The display frame as in claim 1, wherein said transparent material is selected from the group consisting of glass, Plexiglas®, acrylic, plastic, and polycarbonate.

5. The display frame as in claim 1, wherein a geometric area of said interior area is larger than a geometric area of the media item received therein.

6. The display frame as in claim 5, wherein each of said front plate and said back plate has a thickness of about 2 mm to 5 mm.

7. The display frame as in claim 6, further comprising a dust cover coupled to one of said back plate or said front plate, said dust cover being movable between a covered configuration not allowing access to said interior area and an uncovered configuration allowing access to said interior area.

8. The display frame as in claim 1, further comprising a dust cover pivotally coupled to one of said back plate or said front plate, said dust cover being movable between a covered configuration not allowing access to said interior area and an uncovered configuration allowing access to said interior area.

9. The display frame as in claim 1, further comprising a dust cover removably coupled to one of said back plate or said front plate, said dust cover being movable between a covered configuration not allowing access to said interior area and an uncovered configuration allowing access to said interior area.

10. The display frame as in claim 9, wherein said dust cover is a plug.

11. A display frame for displaying a collectible media item, comprising:
a front plate having a planar configuration and a back plate having a planar configuration opposite said front plate, said front and back plates being parallel to and displaced from one another so as to define an interior area therebetween for receiving the media item;
a pair of side walls opposed to one another and coupled to associated side peripheral edges of said front plate and said back plate, respectively, said pair of side walls extending along said associated side peripheral edges so as to prevent access to said interior area;
a bottom wall coupled to associated bottom peripheral edges of said front plate and said back plate, respectively, said bottom wall extending along said associated bottom peripheral edges so as to prevent access to said interior area;
wherein top peripheral edges of said front plate and said back plate define an open top side that allows access into said interior area;
wherein said first plate, said back plate, said pair of side walls, and said bottom wall are constructed of a transparent material;
a dust cover coupled to one of said back plate or said front plate, said dust cover being movable between a covered configuration not allowing access to said interior area and an uncovered configuration allowing access to said interior area.

12. The display frame as in claim 11, wherein said housing has a unitary molded construction.

13. The display frame as in claim 12, wherein said housing is constructed of an acrylic sheet.

14. The display frame as in claim 11, wherein said transparent material is selected from the group consisting of glass, acrylic, plastic, and polycarbonate.

15. The display frame as in claim 11, wherein a geometric area of said interior area is larger than a geometric area of the media item received therein.

16. The display frame as in claim 25, wherein each of said front plate and said back plate has a thickness of about 2 mm to 5 mm.
